(19) United States
(12) Patent Application Publication
(10) Pub. No.: US 2009/0045808 A1
(43) Pub. Date: Feb. 19, 2009

(54) SYSTEM FOR TESTING CONCEALED CONDUITS

(76) Inventor: Eli Mano, Petach Tikva (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/162,373

(22) PCT Filed: Jan. 25, 2007
(86) PCT No.: PCT/IL2007/000100

§ 371 Date: Jul. 28, 2008

(30) Foreign Application Priority Data
Jan. 29, 2006 (IL) 173402

(51) Int. Cl. G01N 27/72; G01N 27/00

(52) U.S. Cl. 324/220; 324/67

(57) ABSTRACT

A system for testing concealed ducts including a pull cable and a transmitter, the transmitter including a transmission means for emitting radiation disposed at one end of the pull cable and at least one electric wire disposed inside the pull cable, wherein the electric wire or wires enables electrical connection between the transmitter and the transmission means, and a receiver for receiving signals from the transmission means and for indicating strength of the received signals. The scope of the invention includes methods of finding blockage within a conduit pipe and finding the path of a conduit pipe, built into a partition, by inserting a pull cable into a conduit pipe and detecting the location of the front end of the pull cable.

### FIELD AND BACKGROUND OF THE INVENTION

The present invention relates to testing systems and method, and more specifically to a system and a method for testing concealed ducts, such as conduit pipes, which also enables detecting the path of a pipe built into a partition, and to detecting blockage in such a pipe.

In buildings, an important part of the electrical infrastructure includes the electrical cables installed in the walls, ceiling, floors, or other partitions.

First, conduit pipes are built/installed in the partitions and the partitions closed, then the electrical cables are inserted in the conduits.

Usually, a plastic pull cable (often referred to as a “stalband”, or as a “fishtape”) is first inserted from one hole (such as a connection box, electric plug, lamp outlet, etc.) to another.

The electrical cable is attached to the end of the pull cable at the second hole; the pull cable is then pulled back, carrying along the electrical cable which is thus installed between the second and first hole.

When inserting electrical cables in conduit pipe in the partitions, the person inserting the cables sometimes encounters the problem of a blocked conduit pipe.

Such a blockage may be caused by concrete residues in the pipe or depressions in the pipe caused by unexpected forces or moments, etc.

The blockage has to be removed, to allow insertion of the cables.

The problem is in locating the blockage. To open the blockage, the partition has to be opened (locally broken) to enable access there. If the location of the blockage is not known, a large area of the partition may be damaged, at a considerable cost. Such repairs are a waste of time and may create an undesirable delay in a building project.

It is therefore important to locate the blockage, and with as little uncertainty as possible.

This is a difficult problem, considering the fact that the conduit pipes are already installed in the partitions and there is no ready access from the outside.

In addition to the need for precise detection of the location of blockage in a conduit pipe, sometimes the need arises to detect the location, namely the path, of the conduit pipe within the partition, especially in cases in which the partition needs to be drilled or chiseled into, or in cases of adding an additional connection point to an existing conduit pipe. These needs arise not only in cases of conduit pipes designated for or containing electrical wires, but also electronic communication cables for computers, telephones, television, as well as optical fibers, etc.

### SUMMARY OF THE INVENTION

The principle of operation of the system for testing concealed ducts according to the present invention is based on inserting a pull cable into a conduit pipe and detecting the location of the front end of the pull cable as it progresses inside the conduit pipe. Detection of the location can be done for small segments of the pull cable as it is being inserted into the conduit pipe, and continuously marking these end locations. This continuous marking describes the path of progression, namely, the path of the conduit pipe within the partition.

The conduit pipe can be marked with measurement lines, specifying distances from the starting and end points in metric measurements and/or American measurements. This marking can be etched, relief, colored, or any other form of marking.

If there is a blockage in the conduit pipe, its location is in the place where the end of the pull cable is when it cannot be pushed any further into the conduit pipe. Detection of the location of the end of the pull cable within the partition can be achieved by means of a suitable emission device, such as a straight or coiled antenna, emitting energy or generating a field (such as electric, magnetic or both) which can be detected by means of a detector in close proximity to the partition, which can include means of indicating the reception strength and can show, when reception strength is at its maximum, the location of the end of the pull cable.

The energy for this emission device is transmitted via a single-wire or dual-wire electrical conductor from a transmitter or from a radiation source fed from an electrical power source and connected to a pull cable in a location outside of the partition.

When a magnet is disposed at the end of the pull cable and is used for the purpose of generating a magnetic field, there is no need for a transmitter and an electric conductor.

The transmitter can be integrated within a pull cable having a structure nearly identical to that of standard pull cables in common use. Therefore the person inserting the cable need not change his practice and methods of work. Rather, the new pull cable is used just like prior art devices, that is, if there are no obstructions in the conduits.

The system for testing concealed ducts can also be used to mark a point on both sides of a partition, such as a ceiling or wall, etc. Such a marking is necessary in cases such as drilling a hole or making a small opening in the partition designated to be in a specific location on one side of the partition, while the drilling or opening is performed from the other side of the partition. An example of such a case when there are cupboards on the first side of a wall and there is no convenient access to this wall, while the other side of the wall can be easily accessed with a drill or other tolls, and the hole or opening is not supposed to damage the cupboards.

Finding the desired location for drilling the hole or making the opening can be done when the transmission means is held at the desired location of the hole close to the first side of the partition, and the receiver is used to mark the desired point on the other side of the partition.

According to the present invention there is provided a system for testing concealed ducts including: (a) a pull cable having a first end and a second end; (b) a transmitter, the transmitter including: (i) a transmission means for emitting radiation located near the first end of the pull cable; and (ii) at least one electric wire disposed inside the pull cable, wherein the at least one electric wire enables electrical connection between the transmitter and the transmission means; and (c) a receiver for receiving signals from the transmission means and for indicating strength of the received signals.

According to further features in preferred embodiments of the invention, the system for testing concealed ducts further includes: (d) a pull loop disposed at the first end of the pull cable.

According to further features in preferred embodiments of the invention, the transmitter uses RF waves, and the receiver is so devised as to receive the RF waves.

According to further features in preferred embodiments of the invention, the transmitter uses RF waves in the Bluetooth range.

According to further features in preferred embodiments of the invention, the transmission means uses RF waves in the ISM range.

According to further features in preferred embodiments of the invention, the transmission means uses RF waves in the ZIGBEE range.

According to further features in preferred embodiments of the invention, the transmission means uses ultrasonic waves, and the receiver is calibrated to receive ultrasonic waves.

According to further features in preferred embodiments of the invention, the transmission means uses AC magnetic fields, and the receiver is calibrated to receive magnetic fields.

According to further features in preferred embodiments of the invention, the transmission means uses AC electric fields, and the receiver is calibrated to receive AC electric fields.

According to further features in preferred embodiments of the invention, the transmission means uses DC magnetic fields, and the receiver is calibrated to receive DC magnetic fields.

According to further features in preferred embodiments of the invention, the transmission means use DC electric fields, and the receiver is calibrated to receive DC electric fields.

According to further features in preferred embodiments of the invention, the system for testing concealed ducts has a modular structure with the transmitter removably connected to the pull cable.

According to further features in preferred embodiments of the invention, the transmitter is removably connected to the second end of the pull cable using mated connectors selected from a group consisting BNC connectors, SMA connectors, and TNC connectors.

According to further features in preferred embodiments of the invention, the transmitter further includes: (ii) an on/off control means.

According to further features in preferred embodiments of the invention, the receiver includes: (i) an on/off switch.

According to further features in preferred embodiments of the invention, the pull loop is part of the transmission means.

According to further features in preferred embodiments of the invention, the transmission means is a straight antenna.

According to further features in preferred embodiments of the invention, the transmission means is an electrical coil.

According to further features in preferred embodiments of the invention, the receiver includes a signal strength and battery indicator.

According to further features in preferred embodiments of the invention, the receiver includes a signal strength indicator selected from a group consisting of a pointer, a control lamp, a vibrating device, a visual display, and a sound loudspeaker.

According to the present invention there is provided a system for testing concealed ducts including: (a) a pull cable having a first end and a second end; (b) a magnet for creating a magnetic field located near the first end of the pull cable; and (c) a receiver for receiving signals from the magnet and for indicating strength of the received signals.

According to further features in preferred embodiments of the invention, the system for testing concealed ducts further includes: (d) a pull loop disposed at the first end of the pull cable.

According to the present invention there is provided a method for finding blockage inside of a conduit pipe, built into a partition, including the steps of: (a) providing a system for testing concealed ducts including: (i) a pull cable having a first end and a second end; (ii) a transmitter, the transmitter including: (A) a transmission means for emitting radiation located near the first end of the pull cable; and (B) at least one electric wire disposed inside the pull cable, wherein the at least one electric wire enables electrical connection between the transmitter and the transmission means; and (iii) a receiver for receiving signals from the transmission means and for indicating strength of the received signals; (b) pushing the first end of the pull cable into the conduit pipe through an entry point; (c) pushing the pull cable further into the conduit pipe until it is impossible to push the pull cable further; (d) connecting the transmitter to the second end of the pull cable; (e) activating the transmitter; (f) activating the receiver; and (g) searching with the receiver for a point with a maximum receiving signal.

According to the present invention there is provided a method for finding a route of conduit pipe, built into a partition, including the steps of: (a) providing a system for testing concealed ducts including: (i) a pull cable having a first end and a second end; (ii) a transmitter, the transmitter includes: (A) a transmission means for emitting radiation located near the first end of the pull cable; and (B) at least one electric wire disposed inside the pull cable, wherein the at least one electric wire enables electrical connection between the transmitter and the transmission means; and (iii) a receiver for receiving signals from the transmission means and for indicating strength of the received signals; (b) pushing the first end of the pull cable into the conduit pipe through an entry point; (c) pushing a first increment of the pull cable further into the conduit pipe; (d) connecting the transmitter to the second end of the pull cable; (e) activating the transmitter; (f) activating the receiver; (g) searching with the receiver for a location of a first point with a maximum receiving signal; (h) marking the location of the first point with a maximum receiving signal on the partition; (i) pushing a second increment of the pull cable further into the conduit pipe; (j) searching with the receiver for a location of a second point with a maximum receiving signal; and (k) marking the location of the second point with a maximum receiving signal on the partition.

According to the present invention there is provided a method for finding a location of a second point on a second side of a partition, located opposite a first point whose location on a first side of the partition is known, including the steps of: (a) providing a system for testing concealed ducts the system including: (i) a transmitter, the transmitter includes a transmission means for emitting radiation; (ii) a receiver for receiving signals from the transmission means and for indicating strength of the received signals; (b) activating the transmitter; (c) activating the receiver; (d) bringing the transmission means close to the first point whose location on the first side of the partition is known; (e) moving the receiver and searching for the location upon the second side of the partition in which the received signal is of maximal strength.

### BRIEF DESCRIPTION OF THE DRAWINGS

FIG. 1 a illustrates a system for testing concealed ducts.

FIG. 1b illustrates a pull cable comprising a part of the system for testing concealed ducts at the end of which is a straight emitting antenna.

FIGS. 1c-1e illustrates cross sections of pull cables showing possible pull cable structures.

FIG. 2 details the structure and operation of a transmitter of one preferred embodiment of the present invention.

FIG. 3 details the structure and operation of a receiver of one preferred embodiment of the present invention.

### DESCRIPTION OF THE PREFERRED EMBODIMENTS

The following list is a legend of the numbering of the application illustrations:
conduit pipes
1 transmitter
3 receiver
11 transmitter power source
12 female connector component
13 transmitter circuits
21 male connector component
22 pull cable
23 pull loop
24 transmission means
25 material granting strength to the pull cable
26 electric wire
31 receiver power source
32 signal strength and battery indicator
33 receiver circuits
34 receiver antenna
100 system for testing concealed ducts
113 transmitter on/off switch
115 transmitter power and battery indicator
132 VCO frequency source
133 transmitter power switch
134 amplifier
135 BPF
231 pull hole
232 straight transmitting antenna
331 receiver on/off switch
332 synthesizer frequency source
334 LNA Detector
335 BPF

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

A preferred embodiment of the present invention will be now described by way of example and with reference to the accompanying drawings.

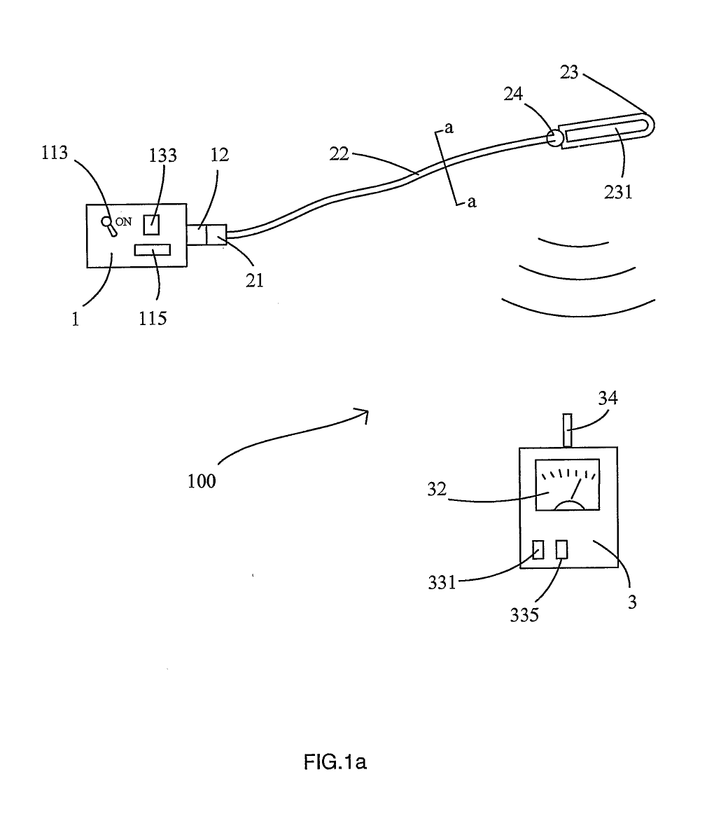

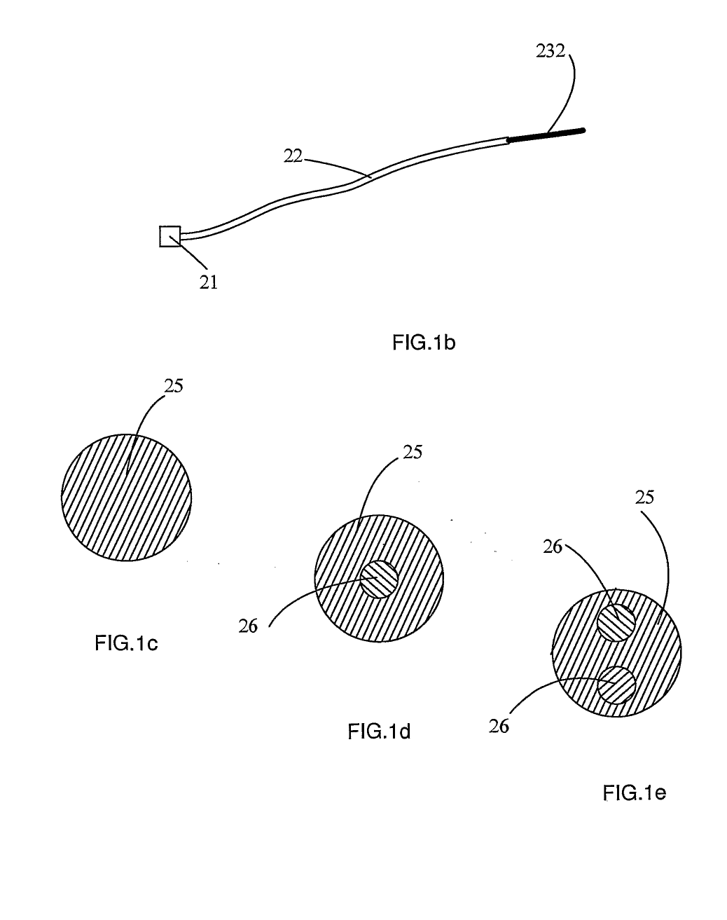

FIG. 1a illustrates a preferred embodiment of a system for testing concealed conduits 100.

A transmitter 1 includes a transmitter on/off switch (or button) 113 for activating the transmitter 1, for example by connecting the power source (not shown in the illustration, can be a battery) to the transmitter circuits (not shown in the illustration).

Transmitter 1 may further include a transmitter power switch 133 for selecting one of a plurality of transmission power levels.

At the beginning of the process of detecting the end of pull cable 22, the receiver antenna 34 may be distant and require a high level of power, however, as it is brought closer, the power can be lowered to a level at which maximum reception indicates the location of the transmission means 24.

A transmitter power and battery indicator 115 may be used to indicate the level of the battery (full/empty) and/or the actual transmitter power. There can also be separate indications for the battery level and transmission power level, as well as for the receiver.

The transmitter 1 is connected to the pull cable 22 through complementary connectors, a female connector component 12 and a male connector component 21, for example a BNC connector in transmitter 1 and a BNC connector installed in the pull cable 22. Many various types of connectors can be used, such as INC or SMA connectors.

In a preferred embodiment the pull cable 22 includes one or two electric wires 26.

From the outside, there is the same familiar plastic cable whose composing material 25 grants the necessary strength.

The single-wire or dual-wire RF cable transfers RF power from the transmitter 1 to the transmission means 24 located near the end of the pull cable 22, close to the wire pull loop 23. The wire pull loop 23 has a wire pull hole 231 therein, to attach to the end of the RF cable single-wire or dual-wire 26.

In another embodiment, the transmitter 1 is located near transmission means 24, with electrical wires inside the pull cable 22 for conducting electric power from a remote battery. The wire pull loop 23, can serve as a transmitting antenna or as part of one.

Radio waves are transmitted from the transmission means 24 to a receiver unit 3 which is located outside of the partition.

When activated by means of an on/off switch (or button) 331 (not shown in the illustration) for example, the transmission means 24 may be detected by means of a signal strength and battery indicator 32. There can be separate indicators for the battery and reception strength.

When the indication is of maximum reception, the receiver antenna 34 is closest to the transmission means 24 within the partition.

A display selection switch 335 may be used to select the desired display in the receiver 3, either the signal reception strength or the battery power.

As noted, there can be separated indications for battery and reception strength, and the indication need not necessarily be on the display, but can use light bulb, LEDs, visual display, sound, or vibration indications.

Various means may be used for the transmission means 24, with corresponding reception means in the receiver 3. These may include radio frequency (RF) waves at various frequencies, ultrasonic waves, AC magnetic fields or AC electrical fields. In another embodiment, DC fields may be used.

RF transmission may be in the Bluetooth ISM 2.4 GHz range, ZigBee (IEEE 802.15.4) or any frequency which is possible, such as the ISM range. Use of non-standard signals, can also be used, as well as COTS (commercial-off-the-shelf) integrated circuits.

As used herein the specification and in the claims section that follows, the term “pull cable” and the like refer to a cable substantially including qualities such as geometrical dimensions, elasticity, strength, fragility, etc., necessary for insertion of an electric conductor or other wires into the pipe, by pushing into the pipe and then pulling the conductor after its having passed through a loop at the end of the cable.

The pull cable serves as an element in the present invention, however does not require a loop at its end. In addition, it can but does not need to be suitable for insertion of a conductor, and its strength against tearing can be weaker than a standard cable serving for insertion of a conductor, in the case that the cable according to the present invention does not serve for insertion of a conductor into a pipe.

FIG. 1b illustrates pull cable 22 serving as part of the system for testing concealed ducts 100, at the end of which is disposed a straight transmitting antenna 232.

An additional possibility is for the pull loop to serve as an antenna. An electrical field can also be generated when an electrical coil is used instead of an antenna.

FIGS. 1c-1e illustrates various cross sections, of section a-a (in FIG. 1a) of the pull cable, showing some of its various possible structures.

FIG. 1c shows a cross section including only the material 25 granting strength to pull cable 22, which can be a plastic material, or any other suitable material. In this case, the system does not include a transmitter, and there is no transmission of directed energy within pull cable 22. This case is suitable for use of a magnet.

FIG. 1d shows a cross section including an electric wire 26. In this case, use of an antenna is suitable.

FIG. 1e shows a cross section including two electric wires 26. In this case, use of a coil is suitable.

The electric wires 26 can be conductors of various kinds such as regular electric wires, regular coaxial cables, or double-shield coaxial cables, transmitting energy to the end of the pull cable 22 and generating an electrical and/or magnetic field in an element disposed at the end. The element can be a transmitting antenna or a core with coiling creating a magnetic field, or sound source generating a sound or vibration signal that can be sensed near the location of the end. In all of these examples, the transmitter generates suitable signals such as an RF signal to the antenna, an alternating current/direct current (AC/DC) to the core, an alternating signal to the sound source, or an electrical signal to the vibrating source.

In each of the cases, the detection of the end is performed by means of a receiver with an indicator which can be a microphone or a display pointer, etc.

In one specific case, in which the pull cable 22 has a magnet at its end or near its end, there is no need for a transmitter, and an indicator can show the magnetic field.

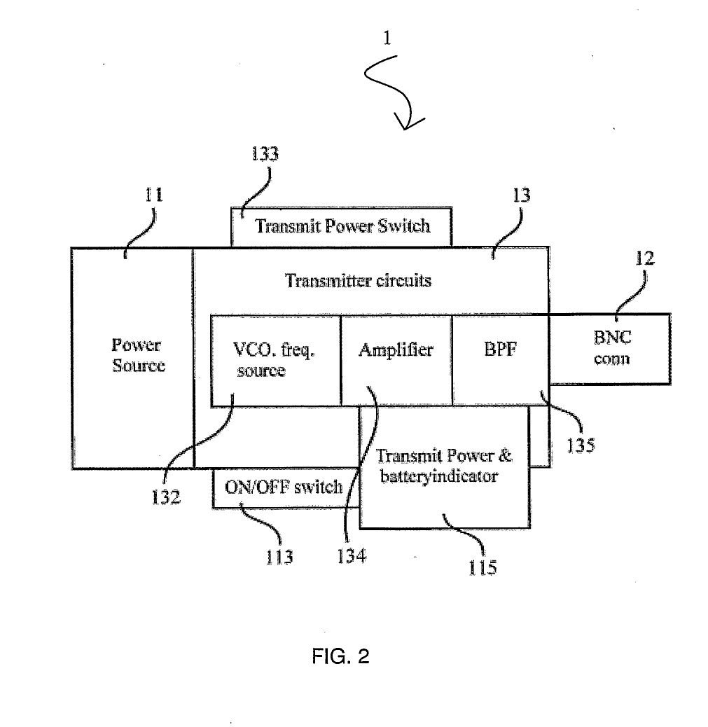

FIG. 2 details the structure and operation of a transmitter 1 of one preferred embodiment of the present invention.

A transmitter power source 11 such as a battery is connected to the transmitter circuits 13 through an on/off switch 113 or through a button.

When activated, the transmitter circuits 13 will generate the required transmission energy. These transmitter circuits 13 may include a voltage controlled oscillator (VCO) or another VCO frequency source 132, an amplifier 134 and a band-pass filter (BPF) 135, connected to a female connector component 12 for outputting the RF energy. This structure is only one of many possible preferred embodiments of the present invention.

The transmitter may further include a transmission power and battery indicator 115 and a transmitter power switch 133.

This illustration shows one possible general structure of a transmitter. The system for testing concealed ducts 100 can also use transmitters of other structures.

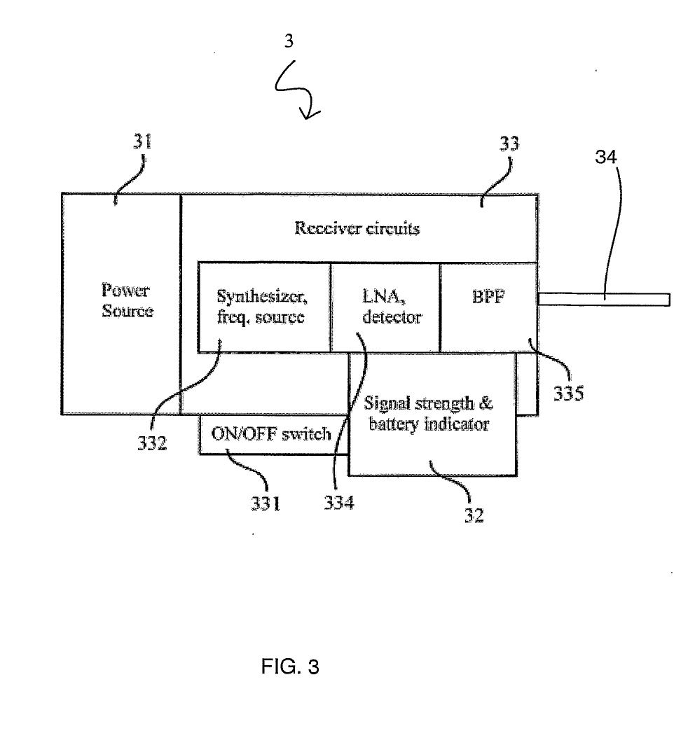

FIG. 3 details the structure and operation of one possible receiver 3, which may include a receiver power source 31 such as a primary or secondary battery, and receiver circuits 33. The receiver circuits 33 may include a synthesizer frequency source 332 or another frequency source for a superhetrodine receiver, low noise amplifier (LNA) means, detector means 334, and a BPF 335.

The receiver may further include a receiver on/off switch 331 or button, and a signal strength and battery indicator 32.

The illustration also shows antenna 34.

Either AC or DC electric or magnetic fields may be used. Each such choice may dictate a different embodiment and system structure, according to relevant engineering considerations.

The end loop of the pull cable 22 (not shown in the illustration) may part of the radiation/transmission means.

The transmission/radiation means may be located close to the end of the pull cable 22, and may transmit an electrical or magnetic field, for example, a transmitter or power source may be attached to the pull cable 22. The system may use the pull cable 22 as a guide for the energy to the radiating element, which may include an antenna or magnetic elements.

The measurement of the reception strength is translated into a reception strength signal indication (RSSI). This indication can also be by means of a speaker emitting sound at a level set according to the reception level.

When a magnet is used, a magnetic indicator such as a compass can be used, likewise, when the transmission is an electromagnetic field, the receiver serves as a radiocompass.

This illustration shows one possible general structure of a receiver. The system for testing concealed ducts 100 can also use receivers of other structures.

Following are two examples of use of the system for testing concealed ducts.

Detecting a Blockage:

The pull cable is inserting by being pushed through the entry point, such as a point in a building partition of a building designated to become an electrical socket, into the pipe in the partition. In the case of a blockage, when it is impossible to push the pull cable any further into the partition, the transmitter will be connected to the end of the pull cable which is outside, then the transmitter will be activated, and the receiver will be activated. In order to detect the blockage, the receiver should be held close to the surface behind which the pipe, into which the pull cable was inserted, is installed. Scanning the surface will give a proportional indicator of the distance from the other end of the pull cable which is within the pipe behind the outer surface which is being scanned. After detection of the blockage, the receiver and transmitter can be switched off.

Detection of the Location of a Pipe Installed in a Partition for the Purpose of Installing an Additional Connection Point:

The transmitter is connected to pull cable and the transmitter and receiver are activated. The end of the pull cable, which is inserted through the entry point, is followed by the receiver, which is held close to the surface behind which the pipe is installed, and gives a proportional indication enabling detecting the path of the end of the pull cable, until the point at which an additional connection point, such as an electrical socket, a telephone socket, a communication network connection, a cable socket, etc., is to be installed. The receiver and transmitter can then be switched off.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for testing concealed ducts comprising:
(a) a pull cable having a first end and a second end;
(b) a transmitter, said transmitter including:
(i) a transmission means for emitting radiation located near said first end of said pull cable; and
(ii) at least one electric wire disposed inside said pull cable, wherein said at least one electric wire enables electrical connection between said transmitter and said transmission means; and
(c) a receiver for receiving signals from said transmission means and for indicating strength of said received signals.

2. The system for testing concealed ducts according to claim 1, further comprising:
(d) a pull loop disposed at said first end of said pull cable.

3. The system for testing concealed ducts according to claim 1, wherein said transmitter uses RF waves, and said receiver is so devised as to receive said RF waves.

4. The system for testing concealed ducts according to claim 3, wherein said transmitter uses RF waves in the Bluetooth range.

5. The system for testing concealed ducts according to claim 3, wherein said transmission means uses RF waves in the ISM range.

6. The system for testing concealed ducts according to claim 3, wherein said transmission means uses RF waves in the ZIGBEE range.

7. The system for testing concealed ducts according to claim 1, wherein said transmission means uses ultrasonic waves, and said receiver is so devised as to receive said ultrasonic waves.

8. The system for testing concealed ducts according to claim 1, wherein said transmission means uses AC magnetic fields, and said receiver is so devised as to receive said magnetic fields.

9. The system for testing concealed ducts according to claim 1, wherein said transmission means uses AC electric fields, and said receiver is so devised as to receive said AC electric fields.

10. The system for testing concealed ducts according to claim 1, wherein said transmission means uses DC magnetic fields, and said receiver is so devised as to receive said DC magnetic fields.

11. The system for testing concealed ducts according to claim 1, wherein said transmission means use DC electric fields, and said receiver is so devised as to receive said DC electric fields.

12. The system for testing concealed ducts according to claim 1, wherein said system for testing concealed ducts has a modular structure with said transmitter removably connected to said pull cable.

13. The system for testing concealed ducts according to claim 12, wherein said transmitter is removably connected to said second end of said pull cable using mated connectors selected from a group consisting of BNC connectors, SMA connectors, and TNC connectors.

14. The system for testing concealed ducts according to claim 1, wherein said transmitter further includes:
(ii) an on/off control means.

15. The system for testing concealed ducts according to claim 1, wherein said receiver includes:
(i) an on/off switch.

16. The system for testing concealed ducts according to claim 2, wherein said pull loop is part of said transmission means.

17. The system for testing concealed ducts according to claim 3, wherein said transmission means is a straight antenna.

18. The system for testing concealed ducts according to claim 3, wherein said transmission means is an electrical coil.

19. The system for testing concealed ducts according to claim 3, wherein said receiver includes a signal strength and battery indicator.

20. The system for testing concealed ducts according to claim 3, wherein said receiver includes a signal strength indicator selected from a group consisting of a pointer, a control lamp, a vibrating device, a visual display, and a sound loudspeaker.

21. A system for testing concealed ducts comprising:
(a) a pull cable having a first end and a second end;
(b) a magnet for creating a magnetic field located near said first end of said pull cable; and
(c) a receiver for receiving signals from said magnet and for indicating strength of said received signals.

22. The system for testing concealed ducts according to claim 21, further comprising:
(d) a pull loop disposed at said first end of said pull cable.

23. A method of finding blockage inside of a conduit pipe, built into a partition, comprising the steps of:
(a) providing a system for testing concealed ducts including:
(i) a pull cable having a first end and a second end;
(ii) a transmitter, said transmitter including:
(A) a transmission means for emitting radiation located near said first end of said pull cable; and
(B) at least one electric wire disposed inside said pull cable, wherein said at least one electric wire enables electrical connection between said transmitter and said transmission means; and
(iii) a receiver for receiving signals from said transmission means and for indicating strength of said received signals;
(b) pushing said first end of said pull cable into said conduit pipe through an entry point;
(c) pushing said pull cable further into said conduit pipe until it is impossible to push said pull cable further;
(d) connecting said transmitter to said second end of said pull cable;
(e) activating said transmitter;
(f) activating said receiver; and
(g) searching with said receiver for a point with a maximum receiving signal.

24. A method of finding a route of conduit pipe, built into a partition, comprising the steps of:
(a) providing a system for testing concealed ducts including:
(i) a pull cable having a first end and a second end;
(ii) a transmitter, said transmitter including:
(A) a transmission means for emitting radiation located near said first end of said pull cable; and
(B) at least one electric wire disposed inside said pull cable, wherein said at least one electric wire enables electrical connection between said transmitter and said transmission means; and
(iii) a receiver for receiving signals from said transmission means and for indicating strength of said received signals;
(b) pushing said first end of said pull cable into said conduit pipe through an entry point;
(c) pushing a first increment of said pull cable further into said conduit pipe;
(d) connecting said transmitter to said second end of said pull cable;
(e) activating said transmitter;
(f) activating said receiver;
(g) searching with said receiver for a location of a first point with a maximum receiving signal;
(h) marking said location of said first point with a maximum receiving signal on said partition;
(i) pushing a second increment of said pull cable further into said conduit pipe;
(j) searching with said receiver for a location of a second point with a maximum receiving signal; and
(k) marking said location of said second point with a maximum receiving signal on said partition.

25. A method of finding a location of a second point on a second side of a partition, located opposite a first point whose location on a first side of said partition is known, comprising the steps of:
(a) providing a system for testing concealed ducts said system including:
(i) a transmitter, said transmitter includes a transmission means for emitting radiation;
(ii) a receiver for receiving signals from said transmission means and for indicating strength of said received signals;
(b) activating said transmitter;
(c) activating said receiver;
(d) bringing said transmission means close to said first point whose location on said first side of said partition is known;
(e) moving said receiver and searching for said location upon said second side of said partition in which said received signal is of maximal strength.
